(19) United States
(12) Patent Application Publication
(10) Pub. No.: US 2023/0090783 A1
(43) Pub. Date: Mar. 23, 2023

(54) OPTICAL WIRING COMPONENT

(71) Applicant: SUMITOMO ELECTRIC INDUSTRIES, LTD., Osaka-shi, Osaka (JP)

(72) Inventor: Tetsu MORISHIMA, Osaka-shi (JP)

(73) Assignee: SUMITOMO ELECTRIC INDUSTRIES, LTD., Osaka-shi, Osaka (JP)

(21) Appl. No.: 17/909,048

(22) PCT Filed: May 12, 2021
(86) PCT No.: PCT/JP2021/018074

§ 371 Date: Sep. 2, 2022

(30) Foreign Application Priority Data
May 13, 2020 (JP) 2020-084636

(51) Int. Cl. G02B 6/36; G02B 6/27; G02B 6/28

(52) U.S. Cl. CPC G02B 6/3612; G02B 6/276; G02B 6/2813

(57) ABSTRACT

An optical wiring component includes an optical waveguide component that has a first end surface and a second end surface and includes a plurality of optical waveguides extending from the first end surface to the second end surface, an angle formed by a plane including the first end surface and a plane including the second end surface being 70° or more, a plurality of optical fibers that have a first end and a second end, one or more first optical connectors that are mounted on the first end and fixed to the optical waveguide component at the first end surface by an adhesive agent, and one or more second optical connectors that are mounted on the second end.

### TECHNICAL FIELD

The present disclosure relates to an optical wiring component. The present application claims priority from Japanese Patent Application No. 2020-84636 filed on May 13, 2020, the entire content of which is incorporated herein by reference.

### RELATED ART

Non-Patent Literature 1 discloses an optical fiber array for connecting a silicon photonics chip. In the optical fiber array of Non-Patent Literature 1, an optical fiber entering a housing from one end surface of the housing is bent, and the optical fiber is guided to another end surface on a plane orthogonal to a plane including the one end surface.

Patent Literature 1 discloses an optical connector in which, by reflecting light emitted from an optical fiber connected to one end surface of a housing by a first lens or a second lens provided in the housing, an optical path of the emitted light in the housing is bent by 90 degrees, and the light whose optical path is bent by the first lens or the second lens is collimated by a third lens or a fourth lens.

### CITATION LIST

### Patent Literature

Patent Literature 1: JP-A-2017-134282

### Non-Patent Literature

Non-Patent Literature 1: “Optical Fiber Array with 90-Degree Bend for Silicon Photonics Chip Coupling”, SEI Technical Review, July 2019, No. 195, p. 8-12

### SUMMARY OF INVENTION

An optical wiring component according to an aspect of the present disclosure includes: an optical waveguide component that has a first end surface and a second end surface, and includes a plurality of optical waveguides extending from the first end surface to the second end surface, in which an angle formed by a plane including the first end surface and a plane including the second end surface is 70° or more; a plurality of optical fibers that have a first end and a second end; one or more first optical connectors that are mounted on the first end and fixed to the optical waveguide component at the first end surface by an adhesive agent; and one or more second optical connectors that are mounted on the second end.

### BRIEF DESCRIPTION OF DRAWINGS

FIG. 1A is a top view schematically showing an optical wiring component according to a first embodiment.

FIG. 1B is a side view schematically showing the optical wiring component shown in FIG. 1A.

FIG. 2A is a schematic view showing a first end surface of an optical waveguide component in FIG. 1A.

FIG. 2B is a schematic view showing a second end surface of the optical waveguide component in FIG. 1A.

FIG. 3 is a top view schematically showing an optical wiring component according to a modification of the first embodiment.

### DESCRIPTION OF EMBODIMENTS

### Technical Problem

When the optical fiber itself is bent as in Non-Patent Literature 1, a space for bending the optical fiber is required, and thus there is a problem that a size of the housing becomes large. It is also conceivable to sharply bend the optical fiber in order to reduce the space, but in this case, bending loss or breakage may occur.

When the optical path is bent by a plurality of lenses as in Patent Literature 1, it is necessary to strictly align a large number of optical components such as lenses, and thus strict accuracy may be required at the time of mounting. Therefore, there is a matter in terms of workability, and there is also a matter that a large optical loss may be caused when the positions of the lenses and the like are slightly shifted. Further, in the optical connector of Patent Literature 1, since the number of optical components to be used is large, distortion due to a difference in a thermal expansion coefficient between the components and an adhesive agent is likely to occur. Therefore, there is also a matter that an increase in an optical loss and breakage are likely to occur at the time of temperature change (when a temperature becomes 100° C. or higher).

An object of the present disclosure is to provide an optical wiring component including a bent optical waveguide, which may be reduced in a size, is excellent in workability and an optical loss, and is less likely to cause an increase in an optical loss or breakage even at the time of temperature change.

### Advantageous Effects of the Present Disclosure

According to the configuration of the present disclosure, it is possible to provide the optical wiring component including the bent optical waveguide, which may be reduced in a size, is excellent in workability and an optical loss, and is less likely to cause an increase in an optical loss or breakage even at the time of temperature change.

### DESCRIPTION OF EMBODIMENTS OF THE PRESENT DISCLOSURE

First, embodiments of the present disclosure will be listed and described. An optical wiring component according to an aspect of the present disclosure includes: an optical waveguide component that has a first end surface and a second end surface, and includes a plurality of optical waveguides extending from the first end surface to the second end surface, in which an angle formed by a plane including the first end surface and a plane including the second end surface is 70° or more; a plurality of optical fibers that have a first end and a second end; one or more first optical connectors that are mounted on the first end and fixed to the optical waveguide component at the first end surface by an adhesive agent; and one or more second optical connectors that are mounted on the second end. In the optical wiring component, the plurality of optical waveguides and the plurality of optical fibers are optically connected at the first end surface.

According to this configuration, it is possible to provide the optical wiring component including the bent optical waveguide, which can be reduced in a size, is excellent in workability and an optical loss, and is less likely to cause an increase in an optical loss or breakage even at the time of temperature change. More specifically, in the above configuration, since the optical path is bent by the optical waveguide instead of bending the optical fiber itself, a space for bending the optical fiber is not required, and a size can be reduced. In addition, since the optical path can be bent only by the optical waveguide component, and the optical waveguide component and the first optical connector are bonded to each other by an adhesive agent, it is not necessary to align a large number of optical components at the time of operation, and an optical loss due to positional deviation of the optical components is less likely to occur. Furthermore, since the number of optical components is small, there are few portions where a difference in a thermal expansion coefficient occurs, and there is a low possibility that distortion occurs at the time of temperature change. As a result, the increase in an optical loss and breakage are less likely to occur even when a temperature changes.

In the optical wiring component, materials of the optical waveguide component and the one or more first optical connectors may be glass containing silica as a main component. As used herein, a term “main component” refers to a component having the largest compositional ratio in terms of mass ratio. According to this configuration, since the optical waveguide component and the first optical connector are formed of the same material, it is possible to further suppress the occurrence of distortion due to the difference in the thermal expansion coefficient. As a result, it is possible to further suppress the increase in an optical loss and breakage at the time of temperature change.

In the optical wiring component, a material of the optical waveguide component may be glass containing silica as a main component, and the one or more first optical connectors may include a ferrule made of a liquid crystal polymer. According to this configuration, since the difference in the thermal expansion coefficient between the material forming the optical waveguide component and the material forming the first optical connector is small, it is possible to further suppress the occurrence of distortion due to the difference in the thermal expansion coefficient. As a result, it is possible to further suppress the increase in an optical loss and breakage at the time of temperature change.

In the optical wiring component, it is preferable that a difference in a thermal expansion coefficient between the optical waveguide component and the one or more first optical connectors is 5×10⁻⁵ or less. According to this configuration, since the difference in the thermal expansion coefficient between the material forming the optical waveguide component and the material forming the first optical connector is small, it is possible to further suppress the occurrence of distortion due to the difference in the thermal expansion coefficient. As a result, it is possible to further suppress the increase in an optical loss and breakage at the time of temperature change.

In the optical wiring component, the one or more first optical connectors and the one or more second optical connectors may be made of different materials. According to this configuration, it is possible to obtain advantages of having a high degree of freedom in material selection, such as manufacturing the second optical connector with a low-cost material.

In the optical wiring component, at least one of the plurality of optical fibers may be a polarization maintaining fiber. According to this configuration, it is possible to suppress a polarization loss when a laser light source is used.

In the optical wiring component, the number of the one or more first optical connectors may be equal to or less than the number of the one or more second optical connectors. According to this configuration, since the number of first optical connectors bonded to the optical waveguide component is smaller than the number of second optical connectors instead of preparing one first optical connector for one second optical connector, it is possible to reduce an adverse effect of variations in shape and the like caused by thermal expansion during component manufacturing.

In the optical wiring component, it is preferable that the plurality of optical fibers include a fiber group including a plurality of optical fibers whose first end surface sides are connected in a ribbon shape, the one or more first optical connectors are multi-core connectors having a plurality of insertion holes, and the plurality of optical fibers forming the fiber group are respectively inserted into the plurality of insertion holes. According to this configuration, it is easy to manufacture the optical wiring component.

In the optical wiring component, a pitch of the plurality of optical waveguides may be different between the first end surface and the second end surface. According to this configuration, optical connection at the second end surface can be performed at a pitch different from that at the first end surface, and for example, optical connection at the second end surface can be performed at a pitch shorter than that at the first end surface. In addition, it becomes easy to match a structure of a counterpart side to which the optical connection is made on the second end surface.

In the optical wiring component, it is preferable that the material of the optical waveguide component contains potassium, fluorine, or germanium. According to this configuration, the optical waveguide can be easily manufactured by a femtosecond laser, and a bending loss in the optical waveguide can be reduced.

In the optical wiring component, it is preferable that hydrogen is further contained as the material of the optical waveguide component. According to this configuration, it is possible to efficiently perform aggregation of potassium or germanium on a portion irradiated with the femtosecond laser or formation of a difference in a refractive index by the femtosecond laser irradiation. As a result, the bending loss in the optical waveguide can be further reduced.

### DETAILS OF EMBODIMENTS OF THE PRESENT DISCLOSURE

Hereinafter, an example of an embodiment of an optical wiring component according to the present disclosure will be described with reference to the drawings. In the following description, the same or corresponding elements are denoted by the same reference numerals or names even in different drawings, and redundant description will be appropriately omitted.

In the following description, terms of “front-rear direction”, “left-right direction”, and “upper-lower direction” may be used. The “front-rear direction” is a direction perpendicular to the first end surface of the optical waveguide component, a direction from the first end surface toward the inside of the optical waveguide component is a “front” direction, and a direction toward the outside is a “rear” direction. The “left-right direction” is a direction parallel to a line of intersection of the first end surface and the second end surface. The “upper-lower direction” is a direction perpendicular to the second end surface.

### First Embodiment

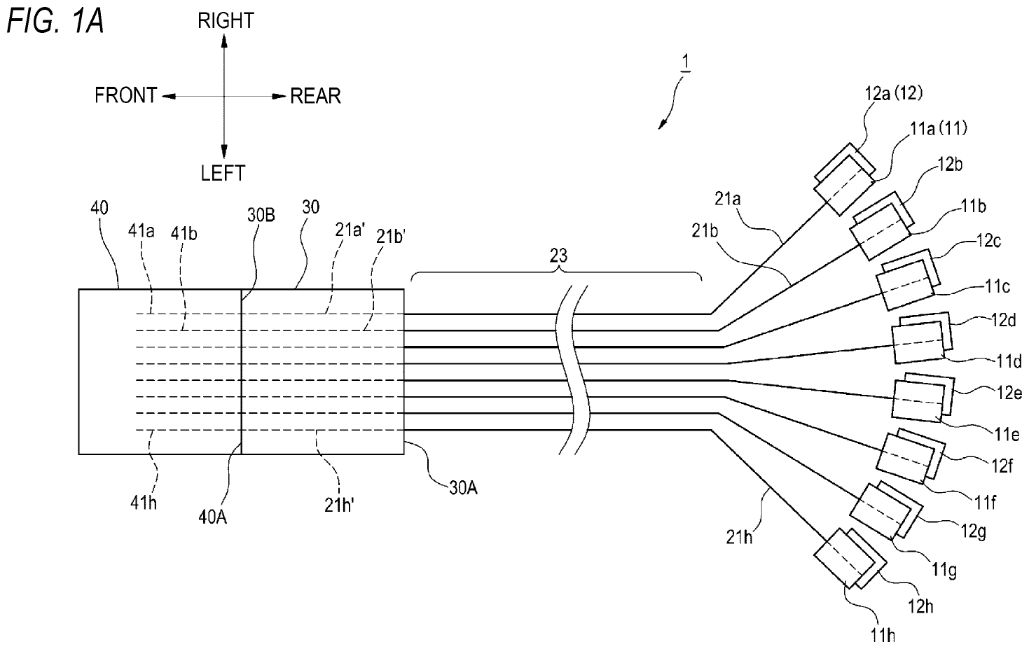

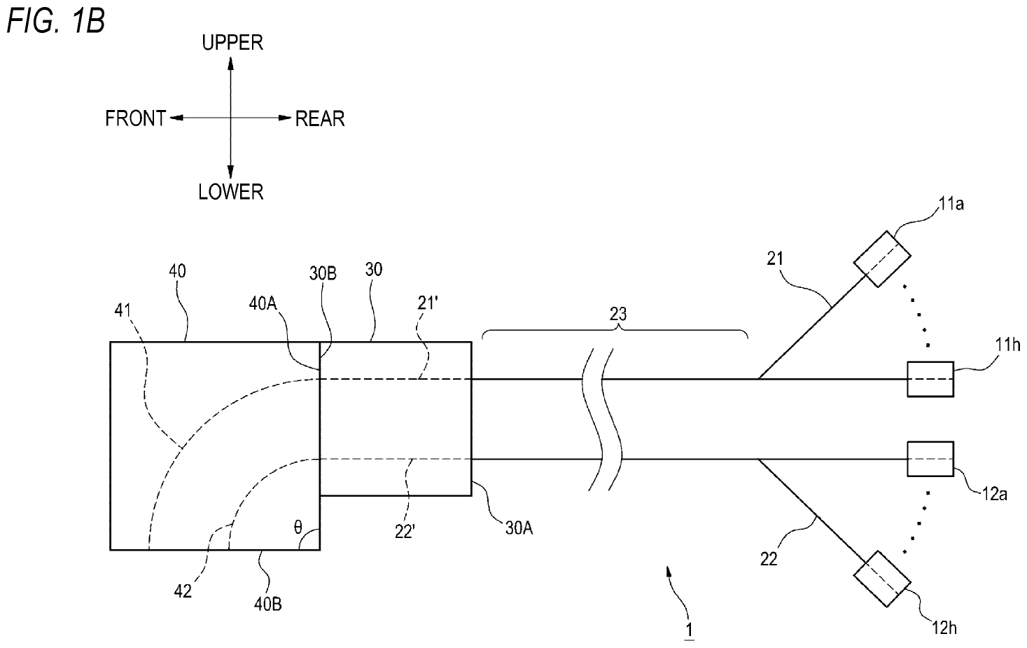

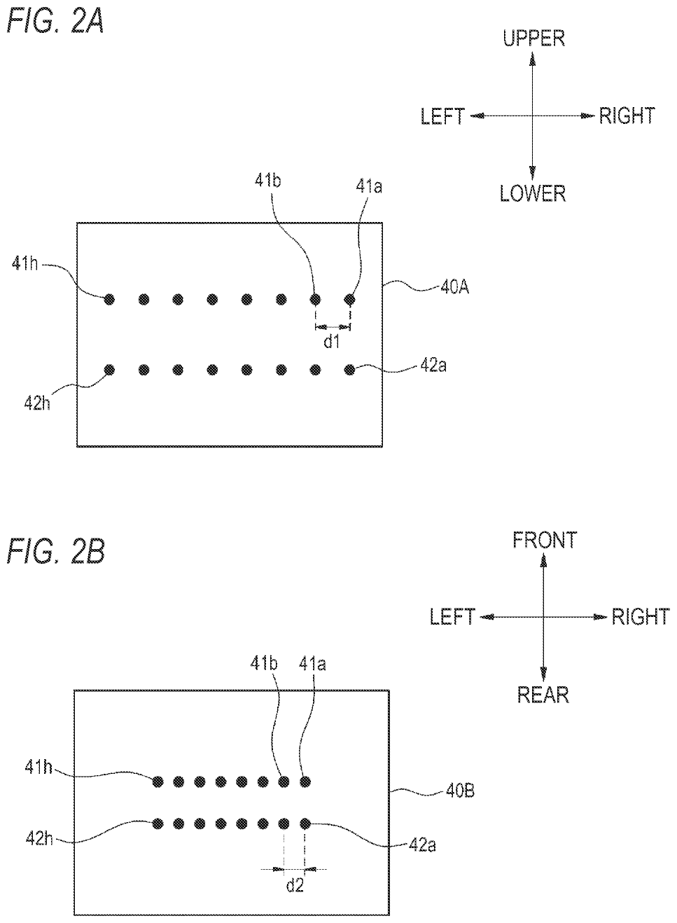

First, an optical wiring component according to a first embodiment will be described in detail with reference to FIGS. 1A and 1B and FIGS. 2A and 2B. FIG. 1A is a top view schematically showing an optical wiring component 1 according to the first embodiment. FIG. 1B is a side view schematically showing the optical wiring component 1 shown in FIG. 1A. FIG. 2A is a schematic view showing a first end surface 40A of an optical waveguide component 40 in FIG. 1A. FIG. 2B is a schematic view showing a second end surface 40B of the optical waveguide component 40 in FIG. 1A.

The optical wiring component 1 includes second optical connectors 11a to 11h and 12a to 12h, optical fibers 21 (including 21a, 21b, and 21h) and 22, a first optical connector 30, and the optical waveguide component 40.

The optical wiring component 1 optically connects an electronic device to another electronic device or the like. The optical wiring component 1 can be suitably used for applications such as an optical transceiver and an optical switch.

The second optical connectors 11a to 11h (hereinafter, also referred to as second optical connectors 11) and 12a to 12h (hereinafter, also referred to as second optical connectors 12) are connectors for optical connection to electronic devices. The second optical connector 11 is mounted on an end portion (second end) on a rear side of the optical fiber 1. The second optical connector 12 is mounted on an end portion (second end) on a rear side of the optical fiber 22.

A structure of the second optical connectors 11, 12 is not particularly limited, and a well-known structure of the related art may be appropriately adopted as the optical connector. A material of the second optical connectors 11, 12 is not particularly limited, but is preferably a resin material such as polyphenylenesulfide (PPS) from a viewpoint of moldability and economic efficiency. The number of the second optical connectors 11, 12 is not particularly limited, and may be appropriately determined according to an electronic device to be optically connected. The number of the second optical connectors 11, 12 may be one for one optical fiber or may be one for a plurality of optical fibers. The second optical connectors 11, 12 may have the same configuration or different configurations. In the present embodiment, the second optical connectors 11, 12 have the same configuration.

Eight optical fibers (hereinafter, also referred to as optical fibers 21) including the optical fibers 21a, 21b, and 21h are optical fibers forming an eight-core optical fiber ribbon, and are connected in a ribbon shape by a connecting portion 23. A first optical connector 30 is mounted on an end portion (first end) on a front side of the optical fiber 21.

In the optical fiber 21, portions located inside the first optical connector 30 are glass fibers 21a′, 21b′, 21h′, and the like (hereinafter, also referred to as glass fibers 21′) formed of only a core layer and a cladding layer. In the optical fiber 21, a portion from the connecting portion 23 to the second optical connector 11 is covered with an ultraviolet curable resin around the glass fiber. Although not shown in FIG. 1A, the optical fiber 22 is similar to the optical fiber 21. At least one of the optical fibers 21, 22 may be a polarization maintaining fiber.

The first optical connector 30 includes a rear end surface 30A, a front end surface 30B, and a plurality of insertion holes (not shown). The insertion hole extends from the rear end surface 30A to the front end surface 30B. The glass fibers 21′, 22′ are inserted through the insertion holes, respectively. That is, positions of the insertion holes are positions where the glass fibers 21′, 22′ are present in FIGS. 1A and 1B. A so-called V groove may be provided instead of the insertion hole. The number of the first optical connectors 30 is not particularly limited, but is preferably equal to or less than the number of the second optical connectors 11, 12.

A material of the first optical connector 30 is not particularly limited, but it is preferable to use a material having a difference in a thermal expansion coefficient 40 of 5×10⁻⁵ or less from the optical waveguide component. Here, since a material of the optical waveguide component 40 is preferably glass containing silica (SiO₂) as a main component, a ferrule forming the first optical connector 30 is preferably made of glass containing SiO₂ as a main component or a liquid crystal polymer from a viewpoint that the difference in the thermal expansion coefficient from the glass satisfies the above range. Table 1 shows preferable materials of the first optical connector 30 and the second optical connectors 11, 12 and thermal expansion coefficients of the materials. As shown in Table 1, the first optical connector 30 and the second optical connectors 11, 12 are preferably made of different materials.

TABLE 1

| | | Thermal expansion |
|---|---|---|
| | Material | coefficient [1/K] |
| First connector | Glass (BK7) | 7 to 9 × 10⁻⁶ |
| | Glass (Pyrex | 3 to 4 × 10⁻⁶ |
| | (registered trademark)) | |
| | Liquid crystal polymer | 10 to 20 × 10⁻⁶ |
| Second connector | PPS | 5 × 10⁻⁵ |

At the time of manufacturing the optical wiring component 1, the glass fibers 21′, 22′ inserted from the rear end surface 30A are fixed in a state of slightly protruding from the front end surface 30B. Then, a protruding portion is cut to form a fiber end surface to be optically connected to the optical waveguides 41, 42 on the first end surface 40A of the optical waveguide component 40. The fiber end surface may be subjected to a treatment such as polishing. Fiber end surfaces of the glass fibers 21′ are arranged in a row in the left-right direction. In addition, fiber end surfaces of the glass fibers 22′ are arranged in a row in the left-right direction below the fiber end surfaces of the glass fibers 21′.

The front end surface 30B and the first end surface 40A of the optical waveguide component 40 are planar. The front end surface 30B and the first end surface 40A are bonded to each other with an adhesive agent. The adhesive agent is not particularly limited, but it is preferable that a difference in the thermal expansion coefficient between the adhesive agent and the optical waveguide component 40 or the first optical connector 30 is 5×10⁻⁵ or less from a viewpoint of further preventing an increase in an optical loss and breakage at the time of temperature change. In addition, since the adhesive agent may enter between the front end surface 30B and the first end surface 40A, the adhesive agent preferably has a refractive index substantially equal to that of a core of the glass fiber 21′. Specific examples of such an adhesive agent include an optical precision adhesive agent.

The optical waveguide component 40 includes the first end surface 40A, the second end surface 40B, and a plurality of optical waveguides 41 (including optical waveguides 41a, 41b, and 41h) and 42 (including optical waveguides 42a and 42h). An angle θ formed by a plane including the first end surface 40A and a plane including the second end surface 40B is 70° or more (in an example shown in FIG. 1B, the angle θ is 90°.

The optical waveguides 41, 42 extend from the first end surface 40A to the second end surface 40B in the optical waveguide component 40. Each of the optical waveguides 41, 42 is optically connected to the fiber end surface of any of the glass fibers 21′, 22′ at the first end surface 40A. In addition, each of the optical waveguides 41, 42 is optically connected to another electronic device or the like at the second end surface 40B.

Each of the optical waveguides 41, 42 includes a high refractive index portion and a low refractive index portion having a refractive index lower than that of the high refractive index portion and surrounding the high refractive index portion. Light incident on the optical waveguides 41, 42 from the fiber end surface travels through the high refractive index portion due to a light confinement effect caused by a difference in the refractive index between the high refractive index portion and the low refractive index portion, and is emitted from the second end surface 40B. Similarly, light incident on the optical waveguides 41, 42 from the second end surface 40B side travels through the high refractive index portion and is emitted from the first end surface 40A.

The material of the optical waveguide component 40 is preferably glass containing SiO₂ as a main component, and more preferably glass doped with potassium, fluorine, or germanium, and preferably further contains hydrogen in addition to the glass and the above dopants.

A method of forming the optical waveguides 41, 42 is not particularly limited, but the optical waveguides 41, 42 can be formed by irradiating a glass member containing SiO₂ as a main component and containing any one of the above dopants with a femtosecond laser. Specifically, the optical waveguides 41, 42 having a desired path can be formed by converging a laser beam from the femtosecond laser inside the glass member to cause aggregation or diffusion of the dopant at a converging position, and then moving the converging position. The high refractive index portion is formed at the converging position of the laser beam, and the low refractive index portion is formed around the converging position. In addition, by injecting hydrogen into the glass member, the difference in the refractive index between the high refractive index portion and the low refractive index portion can be increased.

The paths of the optical waveguides 41, 42 are not particularly limited, but at least a part thereof is preferably curved in the optical waveguide component 40. In addition, a pitch of the optical waveguides 41, 42 at the first end surface 40A may be different from a pitch of the optical waveguides 41, 42 at the second end surface 40B. In a case of varying the pitch, it is preferable to gradually change the pitch from the first end surface 40A toward the second end surface 40B.

As shown in FIGS. 2A and 2B, in the present embodiment, a pitch d2 between the optical waveguides 41a, 41b on the second end surface 40B is smaller than a pitch d1 between the optical waveguides 41a, 42b on the first end surface 40A. The pitch d1 may be determined based on a diameter of the optical fiber 21, a pitch of the optical fibers 21 in the optical fiber ribbon, and the like. In addition, the pitch d2 may be determined based on the structure of a counterpart electronic device or the like to be optically connected to the second end surface 40B. As an example, the pitch d1 is 250 μm, and the pitch d2 is 125 μm or less. The pitch d2 may be larger than the pitch d1.

### Modification

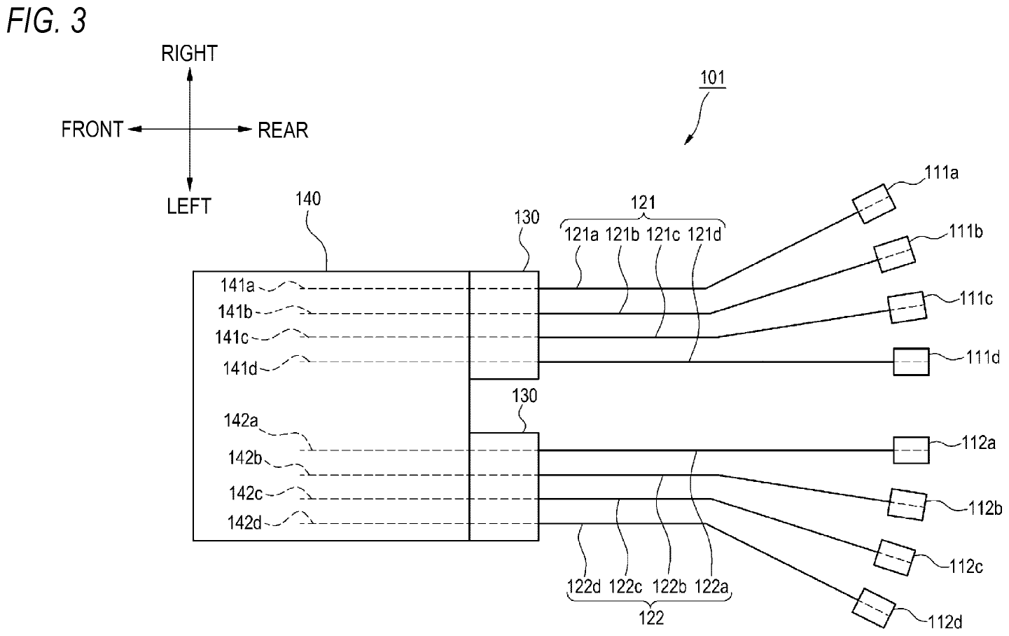

Next, a modification of the first embodiment will be described with reference to FIG. 3. FIG. 3 is a top view schematically showing an optical wiring component 101 which is a modification of the optical wiring component 1. The optical wiring component 101 is an example in which the number of members is changed.

The optical wiring component 101 includes second optical connectors 111a to 111d and 112a to 112d, optical fibers 121a to 121d (hereinafter also collectively referred to as “optical fibers 121”) and optical fibers 122a to 122d (hereinafter also collectively referred to as “optical fibers 122”), first optical connectors 130, and an optical waveguide component 140.

In the optical wiring component 101, the optical fibers 121, 122 are four-core optical fiber ribbons. The optical wiring component 101 includes two first optical connectors 130. The number of the first optical connectors 130 is less than the number of the second optical connectors 111a to 111d and 112a to 112d.

Four glass fibers are inserted into each of the first optical connectors 130. In addition, the first optical connectors 130 are bonded to the optical waveguide component 140 side by side in the left-right direction. In the optical waveguide component 140, optical waveguides 141a to 141d corresponding to the first optical connector 130 on a right side and optical waveguides 142a to 142d corresponding to the first optical connector 130 on a left side are formed. Other configurations are the same as those of the optical wiring component 1 according to the first embodiment.

Although the present invention has been described in detail with reference to specific embodiments, it will be apparent to those skilled in the art that various changes and modifications can be made without departing from the scope of the present invention. The number, positions, shapes, and the like of the constituent members described above are not limited to those in the above embodiment, and can be changed to suitable numbers, positions, shapes, and the like on a premise that the present invention is achieved.

### REFERENCE SIGNS LIST

1, 101 optical wiring component

11a to 11h (11), 12a to 12h (12), 111a to 111d, 112a to 112d second optical connector

21, 21a, 21b, 21h, 22, 121a to 121d (121), 122a to 122d (122) optical fiber

21′, 21a′, 21b′, 21h′, 22′ glass fiber

23 connecting portion

30, 130 first optical connector

30A rear end surface

30B front end surface

40, 140 optical waveguide component

40A first end surface

40B second end surface

41, 41a, 41b, 41h, 42, 42a, 42h, 141a to 141d, 142a to 142d optical waveguide d1, d2 pitch

θ angle formed by plane including first end surface and plane including second end surface

1. An optical wiring component comprising:
an optical waveguide component that has a first end surface and a second end surface and includes a plurality of optical waveguides extending from the first end surface to the second end surface, an angle formed by a plane including the first end surface and a plane including the second end surface being 70° or more;
a plurality of optical fibers that have a first end and a second end;
one or more first optical connectors that are mounted on the first end and fixed to the optical waveguide component at the first end surface by an adhesive agent; and
one or more second optical connectors that are mounted on the second end.

2. The optical wiring component according to claim 1,
wherein the plurality of optical waveguides and the plurality of optical fibers are optically connected at the first end surface.

3. The optical wiring component according to claim 1,
wherein materials of the optical waveguide component and the one or more first optical connectors are glass containing silica as a main component.

4. The optical wiring component according to claim 1,
wherein a material of the optical waveguide component is glass containing silica as a main component, and
the one or more first optical connector includes a ferrule made of a liquid crystal polymer.

5. The optical wiring component according to claim 1,
wherein a difference in a thermal expansion coefficient between the optical waveguide component and the one or more first optical connectors is 5×10⁻⁵ or less.

6. The optical wiring component according to claim 1,
wherein the one or more first optical connectors and the one or more second optical connectors are made of different materials.

7. The optical wiring component according to claim 1,
wherein at least one of the plurality of optical fibers is a polarization maintaining fiber.

8. The optical wiring component according to claim 1,
wherein the number of the one or more first optical connectors is equal to or less than the number of the one or more second optical connectors.

9. The optical wiring component according to claim 1,
wherein the plurality of optical fibers include a fiber group including a plurality of optical fibers whose first end surface sides are connected in a ribbon shape,
the one or more first optical connectors are multi-core connectors having a plurality of insertion holes, and
the plurality of optical fibers forming the fiber group are respectively inserted into the plurality of insertion holes.

10. The optical wiring component according to claim 1,
wherein a pitch of the plurality of optical waveguides is different between the first end surface and the second end surface.

11. The optical wiring component according to claim 1,
wherein the material of the optical waveguide component contains potassium, fluorine, or germanium.

12. The optical wiring component according to claim 11,
wherein hydrogen is further contained as the material of the optical waveguide component.
